(19) United States
(12) Patent Application Publication
(10) Pub. No.: US 2026/0257842 A1
(43) Pub. Date: Sep. 3, 2026

(54) A LID ASSEMBLY AND METHOD OF USE THEREOF

(71) Applicant: SIX TRICKS DISTILLING CO. PTY LTD, Mermaid Waters (AU)

(72) Inventors: Christopher MACKLIN, Currumbin (AU); Andrew PILKINGTON, Currumbin (AU)

(21) Appl. No.: 19/163,295

(22) PCT Filed: Mar. 8, 2024
(86) PCT No.: PCT/AU2024/050199

§ 371 Date: Sep. 8, 2025

(30) Foreign Application Priority Data
Mar. 8, 2023 (AU) 2023900634

(51) Int. Cl. B65D 47/12; A47J 43/27; B65D 41/04; B65D 51/24

(52) U.S. Cl. CPC B65D 47/121; A47J 43/27; B65D 41/0442; B65D 41/0492; B65D 51/24

(57) ABSTRACT

The present invention relates to a lid assembly for use with a reusable bottle. In one form, the lid assembly includes: a lid collar releasably connectable to a rim of a bottle, said lid collar having a lower open end and an opposed upper open end in fluid communication with each other; a strainer configured to be positioned between the lower open end of the collar and over the rim of the bottle; a lid closure connectable to the upper open end for sealing said lid assembly; and a lining member configured to be received within the lid collar and line an internal surface of the lid collar so that any fluid poured form the lid assembly does not contact the internal surface of the lid collar.

### TECHNICAL FIELD

The present invention relates to a lid assembly for use with a cocktail shaker or infusion bottle.

### BACKGROUND

Infusion is a chemical process that uses botanicals (typically dried herbs, flowers, berries, fruits, spices or even candies) that are volatile and release their active ingredients in water, oil or alcohol. Generally, the process entails steeping the botanicals in the water, oil or alcohol for a period of time leaving a resultant infusion.

Infusions have become increasingly popular with spirits, particularly gin, due to the resulting new flavours and colours generated.

A problem in general with infusing spirits is that it is typically only done by distilleries, thereby limiting consumer choice in the botanicals used and the resulting new flavours and colours generated.

A further problem with infusing spirits is that it is usually desirable to remove the botanicals prior to serving. In a commercial facility, such as, e.g., a bar, this is ordinarily done with a strainer when pouring the drink. However, strainers are not always available to at home enthusiasts. Accordingly, and in an at home setting, it not uncommon for botanical pieces to be present in the subsequent drink thereby detracting from the experience.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a lid assembly and a reusable bottle including the lid assembly, which may at least partially address one or more of the problems or deficiencies mentioned above or which may provide the public with a useful or commercial choice.

According to a first aspect of the present invention, there is provided a lid assembly for use with a bottle, said assembly including:
a lid collar releasably connectable to a rim of the bottle, said lid collar having a lower open end and an opposed upper open end in fluid communication with each other;
a strainer configured to be positioned between the lower open end of the collar and over the rim of the bottle;
a lid closure connectable to the upper open end for sealing said lid assembly; and
a lining member configured to be received within the lid collar and line an internal surface of the lid collar so that any fluid poured from the lid assembly does not contact the internal surface of the lid collar.

According to a second aspect of the present invention, there is provided a reusable bottle including:
a container body having a base, a rim and at least one sidewall extending therebetween and defining a volume for containing a liquid fluid; and
a lid assembly including:
   a lid collar releasably connectable to the rim of the container body, said lid collar having a lower open end and an opposed upper open end in fluid communication with each other;
   a strainer configured to be positioned between the lower open end of the collar and over the rim of the container body;
   a lid closure connectable to the upper open end for sealing said lid assembly; and
   a lining member configured to be received within the lid collar and line an internal surface of the lid collar so that any fluid poured from the container body via the lid assembly does not contact the internal surface of the lid collar.

Advantageously, the lid assembly of the present invention provides a convenient way for people to create and enjoy infusion beverages at home as well as in commercial settings. By incorporating a strainer within the lid assembly, an infusion beverage may be readily poured via the lid assembly without the need for a separate strainer. Further, and by being directly compatible with free flow pour spouts, alcoholic spirits measures, measured pour spouts and the like, the integrated strainer of the lid assembly is also likely to be popular amongst bartenders as not only will it result in a more efficient drink serving process (i.e., no separate strainer required when preparing cocktails) but they will also be able to create their own infusions and display their new colours and creations on the back bar with this highly identifiable bottle.

Moreover, and for purists, the lining member of the lid assembly ensures any infusion beverage carefully prepared within a bottle having the lid assembly will not be tainted by material or flavour migration from the materials of the lid assembly. Additionally, the lining member advantageously functions as a funnel when pouring a beverage (i.e., a liquid fluid) to ensure no beverage pools or collects in the cap, but rather freely flows through the opening.

Lastly, and due its high quality design, any bottle provided with the lid assembly of the present invention is likely to be readily reused as a cocktail shaker infusion bottle. Therefore, the present invention represents a sustainable solution to the single-use norm of the liquor industry.

As indicated above, the lid assembly of the present invention is for use with a bottle, preferably in the preparation and serving of infusions. It will therefore be convenient to hereinafter describe the lid assembly with reference to this example application. However, a person skilled in the art will appreciate that the lid assembly is capable of broader applications and may be used with any bottle.

As used herein, the term “liquid fluid” may include any beverage to be served by the lid assembly, preferably any alcoholic beverage, more preferably any alcoholic infusion beverage.

As used herein, the term “infusion” may include any alcoholic beverage prepared by steeping botanicals, such as, e.g., dried herbs, flowers, berries, fruits, spices, or even candies, in the alcoholic beverage for a period of time thereby allowing the botanicals to release their active ingredients and imbue the beverage with new flavours and/or colours.

The bottle may be of any suitable size, shape and construction and may be formed from any suitable material or materials. The bottle may function as a cocktail shaker bottle and/or an infusion bottle.

Generally, the bottle may be formed from a durable material or materials that are easy to clean and hygienic, such as, e.g., metal, plastic or glass material or materials.

As indicated above, the bottle includes a container body.

The container body includes a base, a rim and at least one sidewall extending therebetween and defining a volume for containing the liquid fluid.

The rim may extend from an upper portion of the at least one sidewall and may extend at least partway along an edge of the at least one sidewall, preferably entirely.

The base may be of any suitable shape.

In some embodiments, the base may be in the shape of a triangle, a square, a rectangle, a pentagon, a hexagon, or an octagon, for example.

In other embodiments, the base may be circular or oval-shaped.

In preferred embodiments, the container body may have a circular base with a single curved sidewall extending from an outer edge of the base to the rim.

The container body may be sized and shaped to define any suitably sized said volume for containing the liquid fluid. For example, the container body may have an internal volume of about 0.2 L, about 0.25 L, about 0.5 L, about 0.7 L, about 0.75 L, about 1.0 L, about 1.25 L, about 1.5 L, about 1.75 L, about 2.0 L, about 2.25 L, about 2.5 L, about 2.75 L or even about 3.0 L. Suitably, the container body may typically be sized and shaped to define an internal volume ranging between about 0.5 L and about 1.5 L.

In some embodiments, the outer surface of the at least one sidewall of the container body may include one or more graduations for measuring a volume of the liquid fluid contained therein.

The graduations may be provided in any suitable size, form and location on the sidewall of the container body.

The graduations may be applied by moulding, etching, scribing, engraving, painting, printing or other means, for example.

The graduations may be provided in a linear scale identifying units of measurement in litres or millilitres.

The graduations may typically extend at least partially along a height of the sidewall of the container body.

The rim may define a mouth through which the liquid fluid may enter and exit the container body. The mouth and the base may be substantially aligned along a longitudinal axis of the container body, preferably such that the mouth is located above or over the base.

In some embodiments, the container body may further include a neck extending from an upper portion of the at least one sidewall to the rim. The neck may have a constant diameter or may taper in diameter from the sidewall to the rim, preferably the former. Preferably, the neck may have a narrower diameter than a remainder of the container body.

In some such embodiments, the container body may further include a rounded shoulder portion extending continuously between the at least one sidewall and the neck. The rounded shoulder portion may be defined by a constant or uniformly changing radius or some other suitable curve.

The container body may further include strengthening ribs, indents or formations as is well known in the art for imparting greater structural strength to the container body.

For example, in some embodiments, one or more corrugation or fluting members/formations may be provided along the at least one sidewall. The corrugations or fluting members may at least partially extend between the base and the rim of the container body to strengthen the sidewall. The corrugations or fluting members may be shaped, located and sized in any suitable way.

In other embodiments, the base of the container body may include a central indent, also known as a “punt” to strengthen the container body.

As indicated, the lid assembly includes a lid collar configured to be releasably connectable to the rim of the bottle, or the container body.

The lid collar may have a lower open end connectable to the rim of the bottle, or the container body, and an opposed upper open end. The lower open end and the opposed upper open end may be in fluid communication with each other.

The lid collar may define an internal flow path extending between the lower open end and the opposed upper open end for, in use, the egress of the liquid fluid from the bottle, or the container body, connectable to the lower open end.

The lid collar may have a substantially circular shape sized and shaped to match the mouth of the container body.

The lid collar may include a lower edge, an opposed upper edge and at least one sidewall extending therebetween, preferably a single curved sidewall. The sidewall may be of any suitable thickness. The sidewall may have an outer surface and an opposed inner surface.

In some embodiments, the lower edge may define the lower open end and the opposed upper edge may define the upper open end of the lid collar.

In other preferred embodiments, the lid collar may further include a top wall extending across the upper edge and having a central opening defined therein. The central opening may have a substantially circular shape defined by an inner circular edge of the top wall. In such embodiments, the central opening may constitute the upper open end.

The central opening may advantageously be sized and shaped to at least partially receive a free flow pour spout, an alcoholic spirits measure, measured pour spout or the like therein. Being compatible with pour spouts and the like may encourage the lid assembly to be quickly adopted in commercial settings as well for at home use. Moreover, combining the lid assembly with a pour spout or the like will obviate the need for a bartender to additionally use a strainer as it is already incorporated in the lid assembly. Resultingly, this may advantageously result in more efficient a drink serving process.

The outer surface of the lid collar may include a grip at least partially defined thereon, such as, e.g., ridges, grooves or knurling.

The lid collar and the rim of the bottle, or the container body, may be releasably connectable in any suitable way.

For example, in some embodiments, the lid collar and the rim may be connected together by a connecting mechanism or part thereof. The connecting mechanism or parts thereof may or may not be of integral formation with each of the lid collar and the rim.

In some embodiments, the connecting mechanism may include a first part associated with the lid collar and a second part connectable to the first part and associated with the rim.

The connecting mechanism may include mateable male and female portions that couple together, such as, e.g., by a threaded connection, an interference (snap-fit) connection, a bayonet-type connection or a friction fit connection.

In some such embodiments, the first part of the connecting mechanism associated with the lid collar may include a male formation configured to be inserted into, or coupled with, a female formation of the second part of the connecting mechanism associated with the rim.

Conversely, in other such embodiments, the first part of the connecting mechanism associated with the lid collar may include a female formation configured to at least partially receive, or be coupled with, a male formation of the second part of the connecting mechanism.

In other embodiments, the lid collar and the rim of the bottle, or the container body, may be releasably connectable by way of a threaded connection.

For example, in some such embodiments, the rim, or a rim portion, of the bottle, or the container body, may include an external thread and the lid collar may include an internal thread configured to threadingly engage the external thread of the rim, or the rim portion, and threadingly connect the lid collar and the bottle, or the container body, together.

The internal and external threads may have any suitable thread direction, profile and ratio for complementing one another.

Typically, the internal thread of the lid collar may be defined on the inner surface of the lid collar, preferably extending from the lower edge at least partially towards the upper edge.

The external thread may be defined on an external surface of the rim or a rim portion, preferably extending downwards from the rim at least partially along the neck towards the rounded shoulder portion.

As indicated, the lid assembly further includes a strainer configured to be positioned between the lower open end of the of the lid collar and the rim of the bottle, or the container body.

The strainer may be of any suitable size, shape and construction and may be formed from any suitable material or materials. Typically, the strainer may be formed a durable material or materials that are easy to clean and hygienic, such as, e.g., metal, plastic or glass material or materials.

Generally, the strainer may be a circular disc sized and shaped to fit over the rim of the bottle or the container body, and preferably within the lower open end of the lid collar.

The strainer may include a pair of opposed surfaces interconnected by a side edge.

In some embodiments, the opposed surfaces may include a plurality of openings defined therethrough for, in use, allowing the liquid fluid to pass through and restraining the passage of any solid particulate matter, such as, e.g., botanicals.

In other embodiments, the strainer be a circular disc of mesh configured to, in use, allow the liquid fluid to pass therethrough and restraining the passage of any solid particulate matter.

In some embodiments, the strainer may be a circular disc having an outer flange portion for sitting atop the rim of the bottle, or the container body, and a central mesh portion for allowing the liquid beverage to pass therethrough and restraining any solid particulate matter.

Typically, the strainer may be removable from the lid assembly for cleaning, as needed.

In some embodiments, the lid assembly may further include a sealing washer configured to fit about a periphery of the strainer and form a seal between the rim and the lid collar about a periphery of the strainer.

The sealing washer may be of any suitable size, shape and construction and may be formed from any suitable material or materials.

Generally, the sealing washer may be formed from a resiliently deformable material or materials capable of at least partially deforming for forming a seal about the strainer.

Typically, the sealing washer may be formed from silicone, rubber and/or plastic material or materials.

Suitably, the sealing washer may be a thin disc-shaped plate having an outer ring defining a central annulus. The outer ring may have an upper surface and an opposed lower surface interconnected by opposing edges. The opposing edges may include an outer side edge and an opposed inner side edge.

In preferred embodiments, the inner side edge of the sealing washer may include a groove extending therealong configured to receive therein an outer edge of the strainer. Advantageously, and apart from forming a seal about the strainer, the sealing washer may also frictionally fit within the lower open end of the lid collar and thus assist in retaining the strainer therein.

As indicated, the lid assembly may include a lid closure connectable to the upper open end of the lid collar for sealing the lid assembly, when connected to the bottle, or the container body.

The lid closure may of any suitable size, shape and construction and may be formed from any suitable material or materials.

The lid closure may be of unitary construction or may be formed from two or more lid closure pieces, preferably the latter.

The lid closure may be formed from metal, plastic, rubber or cork material or materials and may be sized and shaped to match the shape of the lid collar.

The lid closure may include a screw-on, a snap-on, or push-on closure, for example.

In its simplest form, the lid closure may include a plug for plugging or sealing the upper open end of the lid collar. The plug may have cylindrical, conical or frustoconical shape.

Typically, the lid closure may include a base and a sealing member for being at least partially received in the open upper end of the lid collar and sealing the lid assembly.

The base may be substantially circular shaped.

The base may include a pair of opposed surfaces extending substantially parallel to each other and interconnected by at least one side edge.

The opposed surfaces may include an outer surface and an opposed inner surface configured to face the upper open end of the lid collar, when connected thereto.

The sealing member may be of any suitable size, shape and construction and formed from any suitable material or materials.

Generally, the sealing member may be formed from a resiliently deformable material or materials capable of at least partially deforming as it is snugly received in the open upper end of the lid collar to thereby seal the open upper end.

Typically, the sealing member may be formed from silicone, plastic, rubber or cork.

The sealing member may protrude outwards from the lower surface of the base, preferably a central portion of the lower surface. The sealing member may be cylindrical, conical or frustoconical in shape for forming a fluid-tight seal when partially inserted into the upper open end, preferably a frustoconical shape.

In some embodiments, the sealing member may be fixedly attached to the base. In other embodiments, the sealing member may be detachable from the base.

In preferred embodiments, the lid closure may include a substantially circular base having an outer surface and an opposed inner surface, a rim, at least one sidewall extending from a periphery of the inner surface to the rim and the sealing member centrally protruding from the inner surface of the base.

In some such embodiments, the inner surface of the circular base may have a central mounting protrusion protruding therefrom upon which the sealing member may be mounted. In turn, the sealing member may include a central plug configured to mount atop the central protrusion and an outwardly extending flange portion configured to extend radially outward from and at least partially across the inner surface of the base of the lid closure.

Like the at least one sidewall of the lid collar, in some embodiments, an outer surface of the at least one sidewall of the lid closure may include a grip at least partially defined thereon, such as, e.g., ridges, grooves or knurling.

When connected, the rim of the lid closure may rest atop, or abut against, an outer periphery of the top wall of the lid collar, the sealing member may be sealingly received in the upper open end of the lid collar and the at least one sidewall of the lid closure may lie substantially flush with the at least one sidewall of the lid collar.

In some embodiments, the lid closure and the lid collar may be hingedly connected by at least one hinge or part thereof, preferably along a common part of the at least one sidewalls of the lid collar and the lid closure.

The at least one hinge may be of any suitable size, shape and form and formed from any suitable material or materials. For example, the hinge may be a barrel hinge, a pivot hinge, a flag hinge or a living hinge.

The at least one hinge or parts thereof may or may not be of integral formation with each of the lid collar and the lid closure.

In some such embodiments, the at least one hinge may include a first hinge part associated with the lid collar, a second hinge part associated with the lid closure and a pivot pin pinning the hinge parts together.

In such embodiments in use, the lid closure may be pivotable relative to the lid collar between open and closed positions about the pivot pin axis.

As indicated, the lid assembly includes a lining member configured to be received in the lid collar and line an internal surface of the lid collar so that any liquid fluid poured via the lid assembly does not contract the internal surface of the lid collar.

The lining member may be of any suitable size, shape and form and formed from any suitable material or materials.

Generally, the lining member may be formed from a resiliently deformable material or materials that are easy to clean, hygienic and substantially inert, such as, e.g., silicone, rubber and/or plastic material or materials.

In some embodiments, the lining member may be in the form of a silicone, rubber or plastic sleeve extending from the lower open end to the upper open end of the lid collar.

In preferred embodiments, the lining member may be in the form of a silicone, rubber or plastic sleeve having an annular base configured to sit atop the strainer (or the sealing washer positioned about the strainer), an annular neck configured to extend through the upper open end of the lid collar, an outwardly-rolled rim extending outwardly from the annular neck for resting atop and about the inner circular edge of the top wall of the lid collar and at least one sidewall extending from the annular base to the annular neck.

In such embodiments, and like the lid collar, the annular base may have a greater diameter than the annular neck and the outwardly-rolled rim to suitably complement the differing diameters of the lower open end and the upper open end of the lid collar, respectively.

In some such embodiments, the lining member may further include a shoulder portion between the at least one sidewall and the annular neck. In such embodiments, the at least one sidewall may extend upwardly from the annular base partially along the inner surface of the lid collar from the lower open end to the shoulder portion near the upper open end of the lid collar. The shoulder portion may then curve inwardly to the annular neck. The shoulder portion may be defined by a constant or uniformly changing radius or some other suitable curve.

In use, the lining member may entirely line the internal flow path of the lid collar. Advantageously, by lining the internal flow path, the lining member may at least partially prevent the liquid fluid from contacting the inner surface of the lid collar thereby preventing, or at least minimising, material or flavour migration from the lid collar into the liquid fluid.

In some embodiments, the inner circular edge of the top wall of the lid collar may be recessed for receiving therein and advantageously interlocking with the outwardly-rolled rim of the lining member for securing the lining member to the lid collar.

In some embodiments, the annular neck of the lining member may advantageously assist in securing part of a free flow pour spout, an alcoholic spirits measure, a measured pour spout or the like to the upper open end of the lid collar. In such embodiments, part of the free flow pour spout, alcoholic spirits measure, measured pour spout or the like may be frictionally received in the annular neck of the lining member within the upper open end of the lid collar, preferably forming a fluid-tight seal between the annular neck of the lining member and the part of the free flow pour spout, the alcoholic spirits measure, the measured pour spout or the like.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is an upper perspective view of a reusable bottle having a lid assembly according to an embodiment of the present invention;

FIG. 2 is a sectional side view schematic of the reusable bottle as shown in FIG. 1;

FIG. 3 is an exploded view of the reusable bottle as shown in FIG. 2; and

FIG. 4 is a sectional side view of the lid assembly of the reusable bottle.

### DETAILED DESCRIPTION

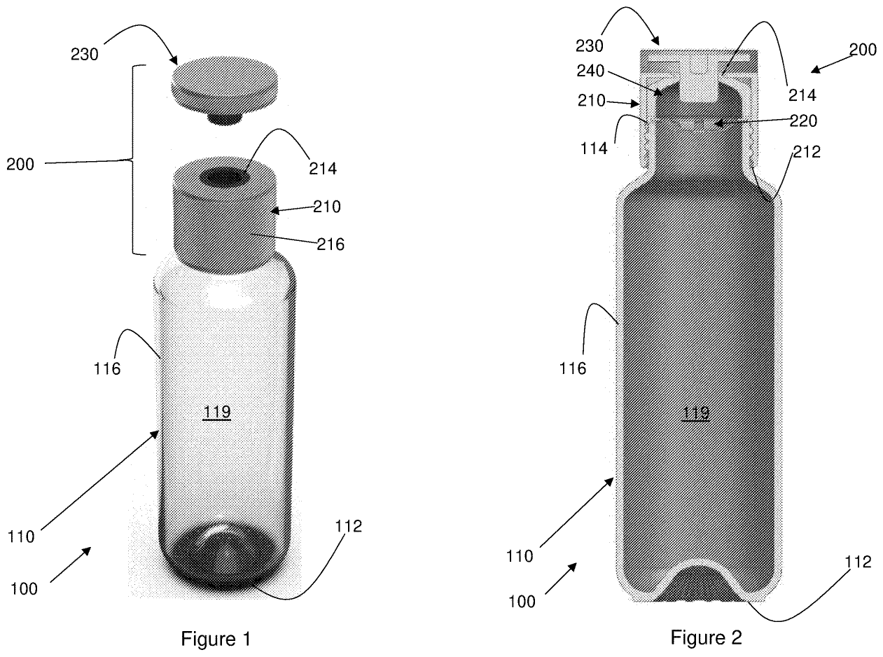

FIGS. 1 to 4 show an embodiment of a bottle (100) or parts thereof, including a lid assembly (200) having an integrated strainer and compatible with a free flow pour spout.

Referring to FIGS. 1 and 2, the bottle (100) includes a container body (110) having a base (112), a rim (114; visible only in FIG. 2) and curved sidewall (116) extending therebetween and defining a volume (119) for containing an infusion beverage (i.e., the liquid fluid).

The bottle (100) further includes the lid assembly (200) for sealing and opening the bottle (100). FIG. 1 shows the bottle (100) when open and FIG. 2 shows the bottle (100) when sealed.

The lid assembly (200) includes a lid collar (210) threadingly connectable to the rim (114; visible only in FIG. 2). The lid collar (210) has a lower open end (212; visible only in FIG. 2) and an opposed upper open end (214). The open ends (212, 214) are in fluid communication with each other to enable a beverage, such as, e.g., an infusion, to be poured from the bottle (100) via the open ends (212, 214).

Referring to FIG. 2, the lid assembly (200) further includes a strainer (220) configured to be positioned over the rim (114) of the container body (110) and clamped in place, when the lid collar (210) is threadingly connected to the rim (114) of the container body (110) as shown.

As shown in both FIGS. 1 and 2, the lid assembly (200) also includes a lid closure (230) connectable to the upper open end (214) of the lid collar (210) for sealing the lid assembly (200) and the bottle (100), as shown in FIG. 2.

Lastly, and again with reference to FIG. 2, the assembly (200) includes a lining member (240) received within the lid collar (210) for lining an internal surface of the lid collar (210) so that any infusion beverage poured from the container body (110) via the lid assembly (200) is not tainted by material or flavour migration from the lid collar (210). Additionally, the lining member (240) advantageously functions as a funnel when pouring a beverage to ensure no beverage pools or collects in the lid assembly (200).

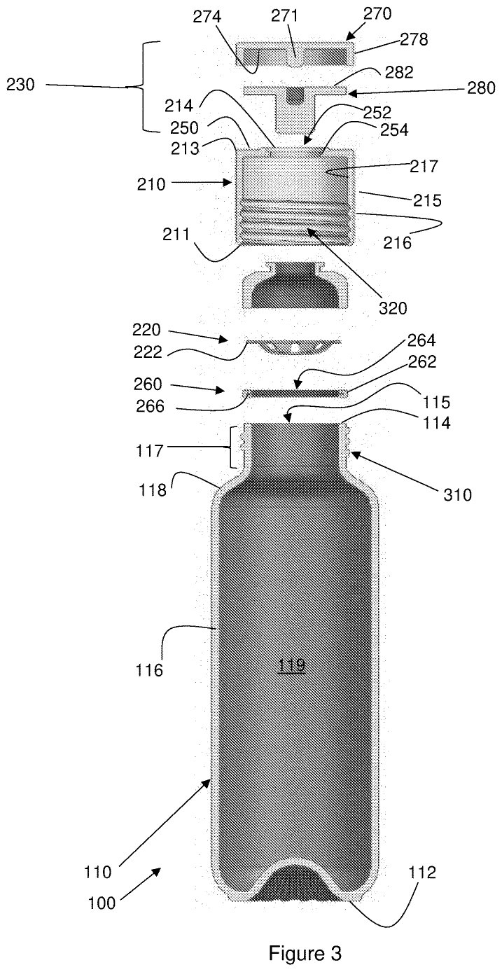

Referring to FIG. 3, the container body (110) is formed from glass and includes the base (112), the rim (114) and the curved sidewall (116) extending therebetween defining the volume (119).

The rim (114) defines a mouth (115) through which the infusion beverage enters and exits the container body (110). The mouth (119) and the base (112) substantially align along a longitudinal axis of the bottle (100) such that the mouth (119) is located above or over the base (112).

The container body (110) further includes a neck (117) extending from an upper portion of the curved sidewall (116) to the rim (114). The neck (117) and mouth (115) are characterised by a relatively constant diameter, which is narrower than a remainder of the container bottle (110).

A rounded shoulder portion (118) defines a continuous transition from the curved sidewall (116) to the neck (117) of the container body (110). The rounded shoulder portion (118) is defined by a constant or uniformly changing radius or some other suitable curve.

The container body (110) is sized and shaped to define any suitably sized volume (119) for containing the infusion beverage. Typically, the container body (110) will have an internal volume (119) ranging between about 0.5 L and about 1.5 L.

As shown, the base (112) of the container body (110) includes a central indent, also known as a “punt” for imparting greater structural strength to the container body (110).

The lid collar (210) defines an internal flow path extending between the lower open end (212) and the opposed upper open end (214) to a beverage to be poured from the bottle (100).

The lid collar (210) has a substantially circular shape sized and shaped to match the mouth (119) of the container body (110).

The lid collar (210) is formed from durable material or materials that are easy to clean and hygienic, typically metal or plastic material or materials.

Specifically, the lid collar (210) includes a lower edge (211), an opposed upper edge (213) and a curved sidewall (215). The sidewall (215) has an outer surface (216) and an opposed inner surface (217).

A top wall (250) extends across the upper edge (213) and has a central opening (252) defined therein. The central opening (252) has a substantially circular shape defined by an inner circular edge (254) of the top wall (250). The central opening (252) constitutes the upper open end (214).

Referring briefly to FIG. 1, the outer surface (216) of the lid collar (210) has knurling defined thereon to provide a grip.

Referring back to FIG. 3, and as indicated, the rim (114) of the container body (110) and the lid collar (210) are threadingly connected together.

As shown, the rim (114) includes an external thread (310) and the lid collar (210) includes an internal thread (320) configured to threadingly engage the external thread (310) of the rim (114) and releasably connect the lid collar (210) to the container body (110).

The internal thread (320) of the lid collar (210) is defined on the inner surface (217) of the lid collar (210) and extends from the lower edge (211) at least partially towards the upper edge (213).

The external thread (310) is defined on an external surface of the rim (114) and extends downwards from the rim (114) at least partially along the neck (117) towards the rounded shoulder portion (118).

As shown, the strainer (220) is configured to be positioned atop the rim (114) of the container body (110) and is clamped in place when the lid collar (210) is threadingly connected to the rim (114) of the container body (110).

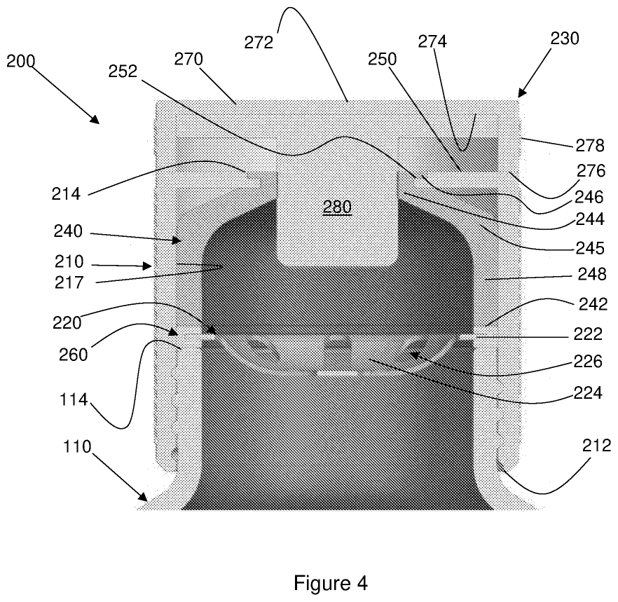

Referring to FIG. 4, the strainer (220) is formed from durable material or materials that are easy to clean and hygienic, typically metal or plastic material or materials.

The strainer (220) is a circular-shaped disc sized and shaped to sit atop the rim (114) and within the lower open end (212) of the lid collar (210).

The strainer (220) has an outer circular flange (222) for sitting atop the rim (114) and a central portion (224) having a plurality of openings (226) defined therethrough for, in use, allowing the infusion beverage to pass through and restraining the passage of any solid particulate matter, such as, e.g., botanicals. The strainer (220) additionally allows for any residual beverage (i.e., downcomer) to flow back through the strainer (220) when not actively pouring.

The strainer (220) is configured to be removable from the lid assembly (200) for cleaning, as needed.

Referring back to FIG. 3, the lid assembly (200) further includes a sealing washer (260) configured to fit about a periphery of the strainer (220) and form a seal between the rim (114) and the lid collar (210) about a periphery of the strainer (220).

The sealing washer (260) is formed from a resiliently deformable material or materials capable of at least partially deforming for forming a seal about the strainer (220), such as, e.g., silicone.

The sealing washer (260) is a thin disc-shaped plate having an outer ring (262) defining a central annulus (264). The outer ring (262) includes a groove (266) extending along an inner edge configured to receive therein an outer portion of the circular flange (222) of the strainer (220).

Referring to FIG. 4, apart from forming a seal about the strainer (220), the sealing washer (260) also frictionally fits within the lower open end (212) of the lid collar (210) to advantageously assist in retaining the strainer (220) therein.

As indicated, the lid assembly (200) further includes a lid closure (230) connectable to the upper open end (214) of the lid collar (210) for sealing the lid assembly (200), when connected to the container body (110). The lid closure (230) is a push-on closure.

The lid closure (230) includes a substantially circular base (270) having an outer surface (272) and an opposed inner surface (274), a rim (276), a curved sidewall (278) extending from a periphery of the inner surface (274) to the rim (276) and a sealing member (280) the form of a plug having a cylindrical shape centrally protruding from the inner surface (274) of the base (270).

The base (270), the rim (276) and the curved sidewall (278) of the lid closure (230) are generally formed from the same material or materials as the lid collar (210), e.g., metal or plastic material or materials. The sealing member (280) is formed from hard silicone.

Referring back to FIG. 3, in some embodiments, the inner surface of the (274) of the base (270) has a central mounting protrusion (271) protruding therefrom upon which the sealing member (280) is fixedly mounted. In such embodiments, the sealing member (280) further includes an outwardly extending flange portion (282) configured to extend radially outward from and at least partially across the inner surface (274) of the base (270).

Like the outer surface (216) of the lid collar (210), an outer surface of the curved sidewall (278) of the lid closure (230) has knurling defined to provide a grip.

Referring again to FIG. 4, and when connected, the rim (276) of the lid closure (230) rests atop, or abut against, an outer periphery of the top wall (250) of the lid collar (210), the sealing member (280) is sealingly received in the upper open end (214) of the lid collar (210) and the curved sidewall (278) of the lid closure (230) lies substantially flush with the sidewall (215) of the lid collar (210).

As indicated, the lid assembly (200) includes a lining member (240) received within the lid collar (210) for lining an internal surface of the lid collar (210) so that any beverage poured from the container body (110) via the lid assembly (200) is not tainted by material or flavour migration from the lid collar (210).

The lining member (240) is formed from silicone.

The lining member (240) has an annular base (242) configured to sit atop the sealing washer (260) positioned about the strainer (220) atop the rim (114) of the container body (110), an annular neck (244) configured to extend through the upper open end (214) of the lid collar (210), an outwardly-rolled rim (246) extending outwardly from the annular neck (244) for resting atop and about the inner circular edge (254) of the top wall (250) of the lid collar (210) and a curved sidewall (248) extending from the annular base (242) to the annular neck (244).

Like the lid collar (210), the annular base (242) has a greater diameter than the annular neck (244) and the outwardly-rolled rim (246) to suitably complement the differing diameters of the lower open end (212) and the upper open end (214) of the lid collar (210), respectively.

The lining member further includes a shoulder portion (245) defining a continuous transition from the curved sidewall (248) to the annular neck (244). As shown, the curved sidewall (248) extends upwardly from the annular base (242) partially along the inner surface (217) of the lid collar (210) to the shoulder portion (245) near the upper open end (214) of the lid collar (210). The shoulder portion (245) then curves inwardly to the annular neck (244). The shoulder portion (245) is defined by a constant or uniformly changing radius or some other suitable curve.

In use, the lining member (240) entirely lines an internal flow path of the lid collar (210). Advantageously, by lining the internal flow path, the lining member (240) at least partially prevents the beverage from contacting the inner surface (217) of the lid collar (210) thereby preventing, or at least minimising, material or flavour migration from the lid collar (210) into the beverage and possible tainting of the beverage.

As shown, the inner circular edge (254) of the top wall (250) of the lid collar (210) is recessed for receiving therein and advantageously interlocking with the outwardly-rolled rim (246) of the lining member (240) for securing the lining member (240) to the lid collar (210).

The annular neck (244) of the lining member (240) advantageously assists in securing part of a free flow pour spout, an alcoholic spirits measure, a measured pour spout or the like to the upper open end (214) of the lid collar (210). In such embodiments, part of the free flow pour spout, alcoholic spirits measure, measured pour spout or the like is frictionally received in the annular neck (244) of the lining member (240) within the upper open end (214) of the lid collar (210).

Being compatible with pour spouts and the like will encourage the lid assembly (200) to be quickly adopted in commercial settings as well for at home use. Moreover, combining the lid assembly (200) with a pour spout or the like will obviate the need for a bartender to additionally use a strainer as it is already incorporated in the lid assembly (200). Resultingly, this may advantageously result in more efficient a drink serving process.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1-18. (canceled)

19. A lid assembly for use with a bottle, said assembly comprising:
a lid collar releasably connectable to a rim of the bottle, said lid collar having a lower open end and an opposed upper open end in fluid communication with each other;
a strainer configured to be positioned between the lower open end of the collar and over the rim of the bottle;
a lid closure connectable to the upper open end for sealing said lid assembly; and
a lining member configured to be received within the lid collar and line an internal surface of the lid collar so that any fluid poured from the lid assembly does not contact the internal surface of the lid collar, said lining member having an annular base configured to sit atop the strainer, an annular neck configured to extend through the upper open end of the lid collar, an outwardly-rolled rim extending outwardly from the annular neck for resting atop and about an inner circular edge of a top wall of the lid collar and at least one sidewall extending from the annular base to the annular neck.

20. The lid assembly of claim 19, wherein the lid collar comprises a top wall extending across an upper edge and having a central opening defined therein constituting the opposed upper open end, said central opening being sized and shaped to snugly receive a free flow pour spout, an alcoholic spirits measure or measured pour spout or the like therein.

21. The lid assembly of claim 19, wherein the lid collar defines an internal flow path extending between the lower open end and the opposed upper open end for, in use, egress of beverage from the bottle connectable to the lower open end.

22. The lid assembly of claim 21, wherein the lining member lines the internal flow path of the lid collar to prevent beverage from contacting an inner surface of the lid collar thereby preventing, or at least minimising, material or flavour migration from the lid collar into the beverage and tainting of the beverage.

23. The lid assembly of claim 19, further comprising a sealing washer configured to fit about a periphery of the strainer and form a seal between the rim and the lid collar about the periphery of the strainer.

24. The lid assembly of claim 23, wherein an inner side edge of the sealing washer comprises a groove extending therealong configured to receive therein an outer edge of the strainer.

25. The lid assembly of claim 23, wherein the sealing washer functions to form a seal about the strainer and frictionally fit within the lower open end of the lid collar thus assisting in retaining the strainer therein.

26. The lid assembly of claim 19, wherein the lid closure has a substantially circular base having an outer surface and an opposed inner surface, a rim, at least one sidewall extending from a periphery of the inner surface to the rim and a sealing member centrally protruding from the inner surface of the base.

27. The lid assembly of claim 19, wherein the lining member is formed from a silicone, rubber or plastic sleeve.

28. The lid assembly of claim 19, wherein the annular base has a greater diameter than the annular neck and the outwardly-rolled rim to complement differing diameters of the lower open end and the upper open end of the lid collar, respectively.

29. The lid assembly of claim 19, wherein the lining member further comprises a shoulder portion between the at least one sidewall and the annular neck, said at least one sidewall extending upwardly from the annular base partially along the inner surface of the lid collar from the lower open end to the shoulder portion near the upper open end of the lid collar.

30. The lid assembly of claim 19, wherein an inner circular edge of the top wall of the lid collar is recessed for receiving therein and interlocking with the outwardly-rolled rim of the lining member for securing the lining member to the lid collar.

31. The lid assembly of claim 19, wherein the lining member assists in securing part of a free flow pour spout, an alcoholic spirits measure, a measured pour spout or the like to the upper open end of the lid collar by frictionally receiving the part in the annular neck of the lining member within the upper open end of the lid collar.

32. The lid assembly of claim 31, wherein the lining member forms a fluid-tight seal with the part of the free flow pour spout, the alcoholic spirits measure, the measured pour spout or the like received in the annular neck of the lining member.

33. The lid assembly of claim 19, wherein the lining member functions as a funnel when pouring a beverage to ensure beverage freely flows through the lower open end and the opposed upper end of the lid collar without pooling or collecting in the lid collar.

34. The lid assembly of claim 29, wherein the shoulder portion defines a continuous transition from the at least one sidewall to the annular neck.

35. The lid assembly of claim 34, wherein the at least one sidewall of the lining member extends upwardly from the annular base partially along an inner surface of the lid collar to the shoulder portion near the upper open end of the lid collar and wherein the shoulder portion then curves inwardly to the annular neck.

36. A reusable bottle comprising:
a container body having a base, a rim and at least one sidewall extending therebetween and defining a volume for containing a liquid fluid; and
a lid assembly comprising:
a lid collar releasably connectable to the rim of the container body, said lid collar having a lower open end and an opposed upper open end in fluid communication with each other;
a strainer configured to be positioned between the lower open end of the collar and over the rim of the container body;
a lid closure connectable to the upper open end for sealing said lid assembly; and
a lining member configured to be received within the lid collar and line an internal surface of the lid collar so that any fluid poured from the container body via the lid assembly does not contact the internal surface of the lid collar, said lining member having an annular base configured to sit atop the strainer, an annular neck configured to extend through the upper open end of the lid collar, an outwardly-rolled rim extending outwardly from the annular neck for resting atop and about an inner circular edge of a top wall of the lid collar and at least one sidewall extending from the annular base to the annular neck.
